(19) United States
(12) Patent Application Publication
(10) Pub. No.: US 2009/0088333 A1
(43) Pub. Date: Apr. 2, 2009

(54) TARGET MOLECULE EVALUATION METHOD AND APPARATUS

(75) Inventors: Michihiko Aki, Kawasaki (JP); Kenji Arinaga, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/236,810

(22) Filed: Sep. 24, 2008

(30) Foreign Application Priority Data
Sep. 27, 2007 (JP) 2007-252550

(51) Int. Cl. C40B 30/04; C40B 60/12

(52) U.S. Cl. 506/9; 506/39

(57) ABSTRACT

AC potential is applied between a substrate electrode provided on a substrate and a counter electrode, a sample is brought into contact with a probe molecule bound to the substrate electrode, and a fluorescent signal obtained from a fluorescent marker provided on the probe molecule is observed to evaluate a target molecule in the sample that has bound to the probe molecule, wherein the target molecule is evaluated by measuring a signal intensity and/or a signal amplitude.

### CROSS-REFERENCE TO RELATED APPLICATIONS

This application is based upon and claims the benefit of priority from the prior Japanese Patent Application No. 2007-252550, filed on Sep. 27, 2007, the entire contents of which are incorporated herein by reference.

### BACKGROUND OF THE INVENTION

1. Field of the Invention

The present invention relates to a target molecule evaluation technique to be used for DNA chips and other biochips.

2. Description of the Related Art

In recent years, much interest has focused on the field of nanotechnology or “nano” as it is known.

In the field of nanotechnology, research and development has been particularly active in the area of nano-biotechnology, a new field that merges semiconductor nanotechnology and biotechnology and may provide fundamental solutions to existing problems.

In this area of nano-biotechnology, DNA chips (or DNA microarrays) and other biochips, in which multiple different targets consisting of DNA, proteins or other biological molecules are spotted in high-density arrays on substrates formed of glass, silicon, plastic, metal or the like, are of interest as a way of simplifying nucleic acid and protein testing in the fields of clinical diagnosis, drug therapy and the like, and particularly as an effective tool for gene analysis (T. G. Drummond et al., “Electrochemical DNA sensors”, Nature Biotech., 2003, Vol. 21, No. 10, p. 1192-1199; J. Wang, “Survey and summary from DNA biosensors to gene chips”, Nucleic Acids Research, 2000, Vol. 28, No. 16, p. 3011-3016).

In recent years, devices called “MEMS” and “μTAS”, which are prepared based on a technology for evaluating extremely small targets in which a functional molecule or a molecule bound to a functional molecule is bound to part of a solid substrate to form a functional surface (evaluation part), in combination with micromachining techniques and microsensing techniques, have gained attention because they offer great improvements over conventional evaluation sensitivity and evaluation time. “MEMS” is an abbreviation for micro-electro mechanical systems, and signifies a technology for producing extremely small objects with semiconductor processing technology or a precise micromachine prepared using this technology, or more generally a system in which the mechanical, optical, fluid and other functional parts are integrated and miniaturized. “μTAS” is an abbreviation for micro total analysis system, and signifies a small-scale, integrated total analysis system of micropumps, microvalves, sensors and the like. These devices generally have functional surfaces consisting of functional molecules having specific functions, or molecules bound to such functional molecules, fixed (bound) by self-assembling on a substrate. Many methods are used for electrically or optically evaluating reactions on the functional surfaces of these devices.

Of these, optical evaluation methods are methods in which a target (object of evaluation) is modified with a fluorescent dye or other optical label, and is then evaluated quantitatively according to the optical intensity, and these are widely used in DNA chips and the like because of their high sensitivity.

However, a procedure of modifying the target with a label is indispensable in these methods, which requires complex steps such as labeling, washing and the like. Other problems include mis-evaluation due to contamination by the unattached label, and evaluation of targets attached non-specifically to the evaluation part rather than by specific binding with the probe.

Consequently, there is demand for development of highly selective, low-noise evaluation techniques that do not require the target to be modified with a label (non-label techniques), and that avoid mis-evaluation of non-specifically attached substances and the like.

As a label-free (non-label) method of evaluating a target molecule, a method is known in which a chargeable probe molecule is modified with a fluorescent marker, this probe molecule is fixed to an electrode and driven with an electric field, the drive status is monitored by means of a signal from the fluorescent marker, the drive status of the probe molecule changes when the target molecule has bound specifically to the probe molecule, and this change is evaluated by means of the fluorescent marker modifying the probe molecule (U. Rant et. al., “Dynamic Electrical Switching of DNA Layers on a Metal Surface”, Nano Lett., 2004, Vol. 4, No. 12, p. 2441-2445). The principle is that the chargeable probe molecule is attracted or repulsed by the electrical field, changing the distance between the electrode and the marker attached to the tip of the probe molecule, and resulting in changes in the signal from the marker that can be observed. As long as the drive frequency is in a frequency band (about 1 MHz or less) that allows formation of an electrical double layer as a source for the electrical field, a target molecule can be evaluated by observing the signal from the marker, which is synchronized with the drive potential.

Another method is ELISA (Enzyme-linked Immunosorbent Assay) for example, but because in this method it is difficult to clearly distinguish between specifically bound target protein and non-specifically bound proteins, it has been necessary to use chromatography to first remove contaminating proteins contained in a biological sample. A method called SPR (Surface Plasmon Resonance) is also known, in which a protein bound to a sensor is assessed by means of changes in refraction index, but in the case of an unrefined biological sample the change in refraction index caused by binding of the protein to the sensor is small, and is overwhelmed by the larger changes in refraction index caused by contaminating proteins close to the sensor (generally within the laser wavelength used for measurement, such as about 500 nm), or caused by non-specific binding of contaminating proteins to the sensor, making it difficult to detect the target protein. Thus, these conventional methods require that contaminating proteins in a biological sample be first removed by chromatography, making it difficult to reduce the size of a protein chip down to palm size. Moreover, the chromatography conditions (filler, column material, column size, elution solvent) need to be optimized for each type of contaminating protein to be removed, which is also a barrier to easy detection of the target protein.

### SUMMARY OF THE INVENTION

One embodiment provides a target molecule evaluation method for evaluating a target molecule by applying AC potential between a substrate electrode provided on a substrate and a counter electrode, bringing a sample into contact with a probe molecule bound to the substrate electrode, and observing a fluorescent signal obtained from a fluorescent marker provided on the probe molecule to evaluate a target molecule in the sample that has bound to the probe molecule,

wherein the target molecule is evaluated by measuring at least one of a signal intensity obtained from Formula 1 or 1′ and a signal amplitude obtained from Formula 2 or 2′:

Signal intensity=fluorescence intensity with potential 1 applied−background fluorescence intensity (1)

Signal intensity=fluorescence intensity with potential 1 applied (1′)

Signal amplitude={(fluorescence intensity with potential 1 applied−fluorescence intensity with potential 2 applied)/(fluorescence intensity with potential 2 applied−background fluorescence intensity)}×100 (2)

Signal amplitude={(fluorescence intensity with potential 1 applied−fluorescence intensity with potential 2 applied)/(fluorescence intensity with potential 2 applied)}×100 (2′)

where the fluorescent signal obtained with no probe molecule bound to the substrate electrode is taken as a background fluorescence intensity,

potential 1 represents the potential at which maximum fluorescent intensity is obtained when potential is applied with only the probe molecule bound to the substrate electrode and when the potential is varied, and

potential 2 represents the potential at which minimum fluorescent intensity is obtained when potential is applied with only the probe molecule bound to the substrate electrode and when the potential is varied.

Another embodiment provides a target molecule evaluation apparatus for evaluating a target molecule by applying AC potential between a substrate electrode provided on a substrate and a counter electrode, bringing a sample into contact with a probe molecule bound to the substrate electrode, and observing a fluorescent signal obtained from a fluorescent marker provided on the probe molecule to evaluate a target molecule in the sample that has bound to the probe molecule,

the target molecule evaluation apparatus having a signal detection and display part for detecting and displaying at least one of a signal intensity obtained from Formula 1 or 1′ and a signal amplitude obtained from Formula 2 or 2′:

Signal intensity=fluorescence intensity with potential 1 applied−background fluorescent intensity (1)

Signal intensity=fluorescence intensity with potential 1 applied (1′)

Signal amplitude={(fluorescence intensity with potential 1 applied−fluorescence intensity with potential 2 applied)/(fluorescence intensity with potential 2 applied−background fluorescence intensity)}×100 (2)

Signal amplitude={(fluorescence intensity with potential 1 applied−fluorescence intensity with potential 2 applied)/(fluorescence intensity with potential 2 applied)}×100 (2′)

where the fluorescent signal obtained with no probe molecule bound to the substrate electrode is taken as a background fluorescence intensity,

potential 1 represents the potential at which maximum fluorescent intensity is obtained when potential is applied with only the probe molecule bound to the electrode and when the potential is varied, and

potential 2 represents the potential at which minimum fluorescent intensity is obtained when potential is applied with only the probe molecule bound to the electrode and when the potential is varied.

### BRIEF DESCRIPTION OF THE DRAWINGS

FIG. 1 is a schematic view showing the behavior of each part of a target molecule;

FIG. 2 is a schematic view of a target molecule evaluation apparatus used in the examples;

FIG. 3 is a chart showing signal intensity and signal amplitude;

FIG. 4 is a chart showing signal intensity, signal amplitude, fluorescence intensity with potential 1 applied and fluorescence intensity with potential 2 applied; and

FIG. 5 is a graph showing the relationship between signal intensity and thrombin concentration.

### DESCRIPTION OF THE PREFERRED EMBODIMENTS

Embodiments are explained below using drawings, examples and the like. These drawings, examples and the like and explanations are meant to illustrate the present invention, not to limit its scope. Other embodiments may of course be included in the scope of the present invention to the extent that they match its intent.

In the target evaluation method according to one embodiment, AC potential is applied between a substrate electrode provided on a substrate and a counter electrode, a sample is brought into contact with a probe molecule bound to the substrate electrode, and a target molecule in the sample that has bound to the probe molecule is evaluated by observing a fluorescent signal obtained from a fluorescent marker provided on the probe molecule.

This is done by measuring at least one of the signal intensity obtained from Formula 1 or 1′ and the signal amplitude obtained from Formula 2 or 2′. In this case, the fluorescence signal obtained with no probe molecule bound to the substrate electrode is taken as the background fluorescence intensity, while the potential at which maximum fluorescent intensity is obtained when potential is applied with only the probe molecule bound to the substrate electrode and the potential is varied is taken as potential 1, and the potential at which minimum fluorescent intensity is obtained when potential is applied with only the probe molecule bound to the substrate electrode and the potential is varied is taken as potential 2:

Signal intensity=fluorescence intensity with potential 1 applied−background fluorescence intensity (1)

Signal intensity=fluorescence intensity with potential 1 applied (1′)

Signal amplitude={(fluorescence intensity with potential 1 applied−fluorescence intensity with potential 2 applied)/(fluorescence intensity with potential 2 applied−background fluorescence intensity)}×100 (2)

Signal amplitude={(fluorescence intensity with potential 1 applied−fluorescence intensity with potential 2 applied)/(fluorescence intensity with potential 2 applied)}×100 (2′).

The decision whether to use Formulae 1 and 2 or Formulae 1′ and 2′ can be made according to the circumstances, but in the case of quantitative evaluation in which signal intensity and amplitude intensity are compared between different types of targets, it is preferable to use Formulae 1 and 2 because the background fluorescence intensity is calculated and subtracted.

When measuring the background fluorescence intensity, it is possible but not necessary to apply potential to the substrate electrode. When measuring the background fluorescence intensity, moreover, a sample containing the target molecule may be supplied to the electrode, or a liquid (such as saline or buffer solution) containing no target molecule may be supplied to the electrode. When the target molecule itself emits fluorescence, this effect can be removed by supplying a sample containing the target molecule. The sample may be supplied by passing it through the environment of the electrode, or by immersing the electrode in the sample.

Since the AC potential is a potential that causes the movement (such as elongation and contraction or standing vertical and lying horizontal) of the probe molecule that is the source of the signal behavior of the fluorescence marker, it is called the drive potential, and causing this kind of movement is sometimes called driving the probe molecule.

A method for applying AC potential between a substrate electrode provided on a substrate and a counter electrode and observing a signal obtained from a fluorescence marker provided on a probe molecule bound to the substrate electrode to thereby evaluate a target bound to the probe molecule is disclosed for example in Japanese Patent Application Laid-open No. 2005-283560 (claims).

The method according to the embodiment provides a novel technique for evaluating an object of evaluation without a label. It can be applied to both an object of evaluation (that is, a target molecule according to the embodiment) that binds specifically to a probe molecule, and to an object of evaluation that binds non-specifically to a probe molecule.

Specifically, it is possible to comparatively determine target molecules that are objects of evaluation, determine the type of and quantitatively determine a target molecule, determine the dissociation constant of a target molecule, and evaluate a target molecule separately from contaminating substances and the like. This is the meaning of “evaluate” in the context according to the embodiments in this specification.

Comparatively determining target molecules here means showing that multiple different types of target molecules are present together, or showing that target molecules that are objects of comparison are different from one another. Determining the type of a target molecule means showing that a particular target molecule belongs to a particular group of target molecules (such as proteins having a special functional group), or is a target molecule having a specific principal structure (such as a single-stranded DNA or the like), or is a target molecule having a known specific structure. Quantitatively determining a target molecule means determining the amount of a target molecule bound to the probe molecule or determining the concentration of the target molecule in a sample or the like. Evaluating a target molecule separately from contaminating substances means quantitatively determining the target molecule contained in a sample without interference from substances other than the target molecule that are present in the sample.

The present embodiments make it possible for example to distinguish between different target molecules bound specifically to a probe molecule.

Moreover, a particular target molecule bound specifically to a probe molecule (such as a target protein bound specifically to a probe molecule) can be distinguished from a molecule bound non-specifically to the probe molecule (such as a contaminating protein bound non-specifically to the probe molecule) by analyzing the signal changes of the fluorescence marker.

As discussed below, since these differences appear in either the signal intensity or signal amplitude, the molecules are preferably distinguished by comparing the signal amplitude and signal intensity.

Moreover, a target protein can be detected without first removing contaminating proteins contained in a biological sample, and the device can thus be reduced in size to 20 to 60 mm (length) by 30 mm (width) for example because there is no need to provide a chromatography function, which is a barrier to size reduction.

It is thus possible to quantitatively determine a target protein contained in a biological sample without removing contaminating proteins.

It is also possible to determine the binding constant and dissociation constant of a target protein contained in a biological sample without removing contaminating proteins.

The evaluation method and evaluation apparatus according to the embodiments in this specification are extremely useful in the field of nano-biotechnology. These embodiments provide an evaluation method suitable to DNA chips and other biochips, and an evaluation apparatus using this method.

In addition to the target protein, various kinds of contaminating proteins are mixed together in biological samples. For example, about 95% of the total volume of the 65 to 82 mg/mL of proteins contained in serum consists of contaminating proteins (such as albumin and fibrinogen). Thus, the volume of a target protein contained in a biological sample is normally less than 1/1000 of the volume of contaminating proteins, and the probe binds non-specifically to the contaminating proteins. The technique according to the embodiments in this specification can be applied favorably in such cases.

### (Target Evaluation Apparatus)

The target evaluation method described above can be implemented using a target evaluation apparatus for evaluating a target molecule in a sample by applying AC potential between a substrate electrode provided on a substrate and a counter electrode, bringing a sample into contact with a probe molecule bound to the substrate electrode, and observing a fluorescence signal obtained from a fluorescence marker provided on the probe molecule to thereby evaluate the target molecule that has bound to be the probe molecule. This evaluation apparatus includes a potential application part for applying potential between the substrate electrode and counter electrode, a light illumination part for causing emission and quenching of the fluorescence signal from the fluorescence marker, and a signal detection part for detecting the signal from the fluorescence marker. The substrate electrode and counter electrode are used immersed in an aqueous solution. The signal detection part detects at least one of signal intensity obtained by Formula 1 or 1′ above and signal amplitude obtained from Formula 2 or 2′ above. A signal display device is also provided for displaying this signal. The potential application part, light illumination part, signal detection part and signal display device are not particularly limited as to structure as long as they can perform the designated functions, and known devices can be used or used with modification. Visible light or ultraviolet light is used for the light illumination part. One example is argon ion laser light with a wavelength of 514.5 nm.

### (Probe Molecule)

As long as the intent of the present invention is not violated, the probe molecule may be any that can bind to the substrate electrode, and that moves (by elongation and contraction or standing vertical and lying horizontal for example) in response to AC potential so as to change the distance between the fluorescence marker and the substrate electrode, thereby causing emission and quenching of the fluorescence of the fluorescent marker.

The probe molecule may be one that binds specifically or one that binds non-specifically to the target molecule, but when evaluating a biologically derived target molecule such as DNA or a protein, it should preferably have the property of binding specifically to the target molecule.

The probe molecule generally has the function of changing the distance between the fluorescent marker and substrate electrode in response to AC potential. In order for the distance between the fluorescent marker and substrate electrode to change when AC potential is applied, the probe molecule should preferably be capable of being positively or negatively charged. Such a probe molecule is sometimes called a chargeable molecule.

The shape of the probe molecule is not particularly limited and can be selected appropriately according to the object, but examples include strands, particles, plates and combinations of two or more of these and the like. Of these, a strand shape is preferred.

The type of such a probe molecule is not particularly limited and can be selected appropriately according to the object, but it is desirable to include at least one substance selected from the group consisting of proteins, DNA, RNA, antibodies, natural or artificial single-stranded nucleotide bodies, natural or artificial double-stranded nucleotide bodies, aptamers, products obtained by limited degradation of antibodies with proteases, organic compounds having affinity for proteins, biopolymers having affinity for proteins, complexes of these, positively or negatively charged ionic polymers and any combinations of these. This is because these are often susceptible to movement such as elongation and contraction or standing vertical and lying horizontal, and are also easy to bind specifically as probe molecules to target molecules.

From the standpoint of application to medical treatment, diagnosis and the like, desirable examples of probe molecules include serum proteins, tumor fluorescence markers, apoproteins, viruses, auto-antibodies, coagulation and fibrinolysis factors, hormones, drugs in blood, nucleic acids, HLA antibodies, lipoproteins, glycoproteins, polypeptides, lipids, polysaccharides, lipopolysaccharides and the like.

Examples of positively charged ionic polymers preferably include polyamines and DNA that has been positively charged using a guanidine bond in the main chain (guanidine DNA) for example. Desirable examples of negatively charged ionic polymers include negatively charged natural nucleotide bodies, polynucleotides, polyphosphoric acids and the like. One kind alone may be used, or 2 or more kinds may be used in combination.

In the embodiments in the specification, a “nucleotide body” is any one selected from the group consisting of mononucleotides, oligonucleotides and polynucleotides, or a mixture of these. Such substances often have a negative charge. A single strand or double strand can be used. It can also bind specifically to the target molecule by hybridization. Proteins, DNA and nucleotide bodies may also be mixed together. Biopolymers include not only those from living bodies but also those from living bodies that have been processed, and synthetic molecules.

The aforementioned “product” is obtained by limited degradation of an antibody with a protease, and as long as it matches the intent of the present embodiments, may be an antibody Fab fragment or (Fab)₂ fragment, a fragment derived from a Fab fragment or (Fab)₂ fragment, or a derivative thereof or the like.

A monoclonal immunoglobulin IgG antibody for example can be used as an antibody. Alternatively, a Fab fragment or (Fab)₂ fragment of an IgG antibody can be used as a fragment derived from an IgG antibody. A fragment derived from such a Fab fragment or (Fab)₂ fragment or the like may also be used. Examples of organic compounds having affinity for proteins that can be used include nicotinamide adenine dinucleotide (NAD) and other enzyme substrate analogs and enzyme activity inhibitors, neurotransmission inhibitors (antagonists) and the like. Examples of biopolymers having affinity for proteins include proteins that serve as substrates or catalysts for proteins, and constituent proteins of molecular complexes and the like.

A natural nucleotide body or artificial nucleotide body can be used as the probe molecule. Artificial nucleotide bodies include those that are completely artificial and those that are derived from natural nucleotide bodies. An artificial nucleotide body is advantageous in some cases because it provides increased detection sensitivity and stability.

It is possible to use either a single-stranded nucleotide body or a double-stranded nucleotide body that is a pair of single-stranded nucleotide bodies complementary to one another. A single-stranded nucleotide body is preferred from the standpoint of ease of elongation and contraction, while a double-stranded nucleotide body is often desirable for lying horizontal to or standing vertical on the substrate electrode. Different nucleotide bodies can also be used for each electrode. The length of the nucleotide chain can be one residue or more. That is, it may be a mononucleotide chain.

A product obtained by limited degradation of a monoclonal antibody with a protease can be used for the probe molecule. This is useful because it can use binding resulting from reactions such as antigen-antibody reactions, and also functions as a probe molecule binding specifically with a target molecule.

It is desirable to use a monoclonal antibody, a monoclonal antibody Fab fragment or (Fab)₂ fragment or a fragment derived from a monoclonal antibody Fab fragment or (Fab)₂ fragment as the probe molecule. A fragment derived from a monoclonal antibody Fab fragment or (Fab)₂ fragment is a fragment obtained by segmentation of a monoclonal antibody Fab fragment or (Fab)₂ fragment, or a derivative thereof.

It is more desirable to use an IgG antibody, an IgG antibody Fab fragment or (Fab)₂ fragment, or a fragment derived from a IgG antibody or IgG antibody Fab fragment or (Fab)₂ fragment as the probe molecule. A fragment derived from an IgG antibody Fab fragment or (Fab)₂ fragment is a fragment obtained by segmentation of an IgG antibody Fab fragment or (Fab)₂ fragment, or a derivative thereof. An aptamer is also desirable. One reason that these are preferred is that in general, detection sensitivity is better with smaller molecular weights.

From the standpoint of ease of binding with the substrate electrode, the probe molecule should preferably be a polynucleotide having a thiol bond (—S—) such as an alkanethiol group (mercaptohexanol (MCH), for example) or disulfide bond (—S—S—), or include a polynucleotide having a disulfide bond (—S—S—), and DNA or RNA having a terminal thiol bond (—S—) or disulfide bond (—S—S—), or a composite thereof with a protein or the like, is especially desirable. The DNA or RNA may be single-stranded or double-stranded.

The size and length of the probe molecule are not particularly limited and can be selected appropriately according to the object, but when the probe molecule is a polynucleotide, it is preferably about 50 bases long. This is because this length is roughly the same as the thickness of the electrical double-layer film (created by application of potential) that can serve as the driving force of the probe.

### (Target Molecule)

The target molecule is the object of evaluation, and can be determined at will. There may be more than one kind of target molecule. Any molecule capable of binding with the probe molecule can be used as the target molecule. In general a target molecule capable of binding with a probe molecule is selected, but when the object is only to confirm that binding with a probe molecule has occurred or to evaluate differences between this target molecule and a target molecule that binds specifically to a probe molecule, a target molecule that binds non-specifically to the probe molecule may be selected. A target molecule binding specifically to a probe molecule and a target molecule binding non-specifically to a probe molecule may together be called target molecules.

A substance similar to the probe molecule may be used as the target molecule. Of the substances listed above as probe molecules, those that bind specifically to one another are desirable as combinations of a probe molecule and a target molecule.

As the combination of a probe molecule and a target molecule, it is desirable to use a single-stranded DNA as the probe molecule combined with complementary DNA to the single-stranded DNA as the target molecule, or a molecule having affinity for a protein as the probe molecule combined with a protein bound specifically to a molecule having affinity with the protein as the target molecule. This is very useful in the case of DNA chips and protein chips.

The type of “binding” here and the binding site are not particularly limited. Covalent bond, coordinate bond and other forms of chemical bond as well as biological binding, static electric binding, physical adsorption, chemical adsorption and the like can all be considered binding in this sense as long as changes in the fluorescence signal are observed as a result of such binding. When a target molecule binds specifically to a probe molecule, this binding is generally strong, but when a target molecule binds non-specifically to a target molecule, weak binding in which the target molecule merely clusters around the probe molecule may also be included.

### (Sample, Contaminants)

A sample here means a solution containing a target molecule, a solution that may contain a target molecule or a solution in which the presence or absence of a target molecule is to be confirmed. It is normally an aqueous solution, and saline, buffer solution and other solvents are often used. Contaminants here mean substances other than the target molecules that are present in the sample. Contaminants may be those that can bind to a probe molecule or those that cannot. Whether or not something capable of binding to a probe molecule is a target molecule or contaminant is a matter to be determined according to the object of evaluation, and is not fixed.

### (Electrodes)

As long as the intent of the present invention is not violated the substrate electrode according to the embodiments in this specification may be any capable of binding with a probe molecule so that a fluorescence signal obtained from a fluorescence marker provided on the probe molecule bound to the substrate electrode changes in response to AC potential applied between the substrate electrode and a counter electrode, and the form thereof is not particularly limited. Any kind of binding can be used in this case as long as the intent of the invention is not violated, including covalent bond, coordinate bond and other forms of chemical bond as well as biological binding, static electric binding, physical adsorption, chemical adsorption and the like. Chemical bond is preferred from the standpoint of stability of movement of the probe molecule in response to the external field, a chemical bond including a sulfur atom (S) is preferred from the standpoint of ease of binding and controllability, and specifically binding of a thiol bond (—S—), disulfide bond (—S—S—) or the like is preferred.

For example, the substrate electrode according to the embodiments in this specification can be obtained by providing an electrode on a substrate surface and providing the electrode surface with a structural part capable of binding with a target molecule (target molecule binding part). The substrate electrode may be single-layered or multi-layered, or may have a non-layered structure.

The material of the substrate in this case is not particularly limited, and desirable examples include glass (such as quartz glass), ceramics, plastics, metals, silicon, silicon oxide, silicon nitride, sapphire and the like. One kind of material may be used, or 2 or more may be used in combination.

The shape, structure, size and surface properties of the substrate electrode and the number thereof are not particularly limited, and can be selected appropriately according to the object. Examples of shapes include flat plates, circles, ovals and the like. Examples of surface properties include gloss, roughness and the like. The size is not particularly limited, and can be selected appropriately according to the object.

The size, shape and the like of the substrate electrode can be adjusted as desired by coating the surface with an insulating film so that only a part of the substrate electrode is exposed. The number of substrate electrodes is not particularly limited and can be selected appropriately according to the object, and either 1 or 2 or more can be used. Interactions between probe molecules and between combinations of probe molecules and target molecules can be prevented by appropriately limiting the size of the substrate electrodes and the distance between multiple substrate electrodes.

The material, shape, structure, thickness, size and the like of the insulating film in this case are not particularly limited and can be selected appropriately according to the object, but the material may preferably be a resist material for example. Examples of resist materials include g-line resists, i-line resists, KrF resists, ArF resists, F₂ resists, electron beam resists and the like.

The material of the substrate electrode is not particularly limited as long as it is electrically conductive, and can be selected appropriately according to the object. Examples include metals, alloys, conductive resins, carbon compounds and the like. Examples of metals include gold, platinum, silver, copper, zinc and the like. Examples of alloys include alloys of two or more of the metals listed above and the like. Examples of conductive resins include polyacetylene, polythiophene, polypyrrole, poly(p-phenylene), polyphenylenevinylene, polyaniline and the like. Examples of carbon compounds include conductive carbon, conductive diamonds and the like. One of these may be used alone, or 2 or more may be used in combination. Au and other precious metals can be used by preference because they are chemically stable and are suitable as quenching agents for fluorescence markers that emit at a wavelength of 500 to 600 nm. This facilitates fixing on the substrate electrode when using a biopolymer as the probe molecule. Multiple substrate electrodes may also be provided on a substrate.

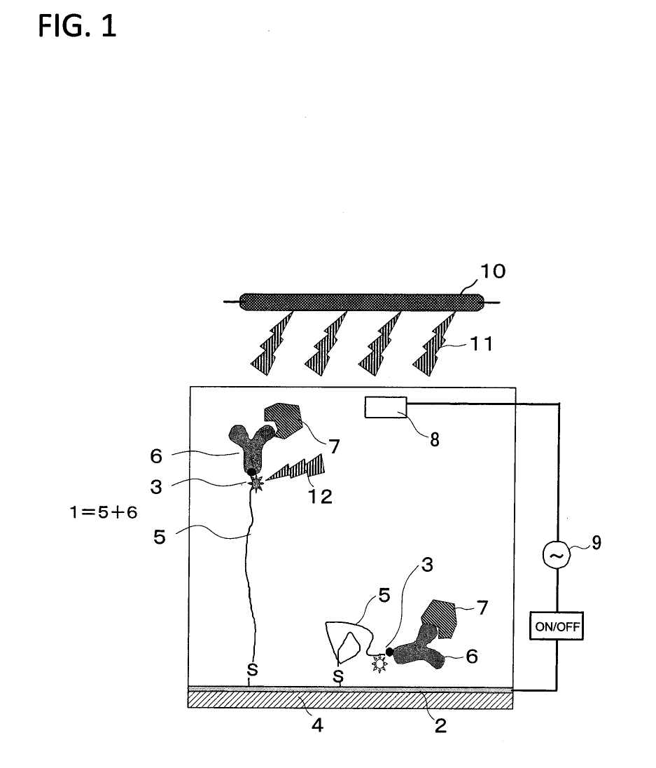

When binding with the probe molecule is possible without a particular probe molecule binding part, no probe molecule binding part need be provided on the surface. An example of a probe molecule consisting of a nucleotide body which is capable of binding directly to an Au layer via its thiol group is probe molecule 1 (part consisting of sensing part 5 and target molecule binding part 6), which has fluorescence marker 3, sensing part 5 with a natural single-stranded oligonucleotide structure and target molecule binding part 6, obtained by reacting for 24 hours at room temperature with a Piranha washed gold electrode to bind it to the Au electrode (substrate electrode 2) on sapphire substrate 4 as shown in FIG. 1. Sensing part 5 is the part having the function of elongating and contracting or standing vertical and lying horizontal, while target molecule binding part 6 is a part that binds to the target molecule. If target molecule binding part 6 has the function of binding specifically to the target molecule, the probe molecule will bind specifically to target molecule 7. The S at the bottom of the single-stranded oligonucleotide structure represents direct binding of the probe molecule to Au electrode 2 via a thiol group. A known metal other than Au can be used for the electrode surface binding with the thiol group. In FIG. 1, a Fab fragment of monoclonal immunoglobulin IgG is fixed to the end of the oligonucleotide chain as target molecule binding part 6, which has the property of binding specifically to the target molecule.

FIG. 1 represents only a model view of a probe molecule and the like of the present embodiments, and other embodiments may of course be included in the present invention. For example, it is not a necessary condition that the sensing part and target molecule binding part be separate in the probe molecule as described above. It is also not a necessary condition that the fluorescent marker, sensing part and target molecule binding part be bound in the order shown in FIG. 1.

The probe molecule is shown elongated in the left part of FIG. 1 and contracted in the right part. When in a contracted state, the probe molecule can be made elongated by applying a specific potential difference between Au electrode 2 and counter electrode 8 by means of external electrical field applicator 9. Fluorescence 12 can then be obtained by exposure to light 11 from light exposure unit 10.

In FIG. 1, the thiol group and fluorescent marker were introduced into the single-stranded oligonucleotide in advance. The thiol group and marker are preferably introduced at the ends of the single-stranded nucleotide, with the marker preferably introduced at the 3′ end if the thiol group is introduced at the 5′ end, or vice versa. In this case, the oligonucleotide chain was fixed on a round Au electrode 1 mm in diameter.

When a probe molecule binding part is provided as part of the substrate electrode, the material thereof can be any capable of binding with the probe molecule, and examples include molecules capable of binding with the probe molecule by chemical bond or intermolecular force. After the probe molecule binding part has bound to the probe molecule, the part consisting of the probe molecule binding part and probe molecule can be considered as a probe molecule. If the probe molecule binding part is capable of elongation and contraction, or of standing vertical and lying horizontal, a probe molecule before binding with the probe molecule binding part does not need to have these functions.

In general, binding between the substrate electrode and the probe molecule should ideally be quantitative, but depending on the type of binding there may be rather large dissociation constant. If this dissociation constant is too large, binding may gradually decline during washing in buffer for example. For this reason, it is normally desirable that the dissociation constant of binding between the substrate electrode and probe molecule be 10⁻⁵ or less.

When such a substrate electrode is immersed in an aqueous solution as the medium and an AC field is applied between it and a counter electrode arranged in the aqueous solution, it becomes possible for the probe molecule to elongate and contract or stand vertical and lie horizontal.

When providing the substrate electrode on the substrate, an adhesive layer can be provided between the two in order to improve adhesiveness between the substrate electrode and the substrate. The material, form, structure, thickness, size and the like of the adhesive layer are not particularly limited and can be selected appropriately according to the object, and examples of materials include chromium and titanium. The structure is not particularly limited and can be selected appropriately according to the object, and may be either a monolayer structure or a layered structure.

The counter electrode according to the embodiments in this specification is arranged facing the substrate electrode so that potential can be applied directly between the two. The form and material of the counter electrode are not particularly limited, and can be selected appropriately from known forms and materials. Examples include platinum wires, tungsten plates, gold mesh, carbon electrodes and the like. The number of counter electrodes is not limited, and there may be more than one.

Instead of a two-electrode system, a three-electrode system using a reference electrode may be adopted for the probe molecule evaluation apparatus. The reference electrode is an electrode for adjusting the potential difference between the substrate electrode and the counter electrode. The form and material of the reference electrode are not particularly limited, and can be selected appropriately from known forms and materials. Examples include silver-silver chloride electrodes, saturated calomel electrodes and the like. The number of reference electrodes is not particularly limited, and there may be more than one.

### (Applied Potential)

The waveform of the AC potential applied by the potential application part is not particularly limited but is normally a sine wave or rectangular wave. A rectangular wave is usually preferred as discussed below. An example of a potential value is ±200 mV vs Ag/Sat. AgCl. The “AC potential” here may also include DC components. Consequently, the average value may be 0 V, or may be a positive value, or may be a negative value. The frequency of the AC potential is also not particularly limited, but if the frequency of the AC potential is so high that the emission/quenching switching of the fluorescent marker cannot keep up, the fluorescence intensity difference (switching amplitude) during application of positive and negative potential in Formula 1 or 1′ and Formula 2 or 2′ will be reduced, so a very high frequency may not be desirable. In general, about 0.5 Hz to 1 kHz is preferred.

### (Fluorescent Marker)

The number of markers in a probe molecule is not particularly limited and can be selected appropriately according to the object, but there must be at least one and may be 2 or more. The position of the marker in a probe molecule is not particularly limited and can be selected appropriately according to the object, but when the probe molecule is a strand it may be positioned at the end, and when the probe molecule is a polynucleotide or contains a polynucleotide, it may be at the 3′ end or 5′ end.

The fluorescent marker may be added by covalent bond as part of the probe molecule before binding with the target molecule, or may be contained within the nucleotide body or the like by being intercalated between adjacent complementary bonds for example. The fluorescent marker should preferably be arranged so that it is located near an end of a probe molecule.

The marker may be any capable of emitting a fluorescent signal in response to AC potential applied between the substrate electrode and counter electrode, as long as the intent of the present invention is not violated. Desirable examples of fluorescent markers include fluorescent dyes, metals, quantum dots (nanocrystals consisting of semiconductor materials a few nm in diameter) and the like.

When the substrate electrode is of metal, the fluorescent dye that does not emit even when exposed to light at an absorbable wavelength as long as it interacts with the metal (for example, when it is positioned near the metal), but which is capable of emitting in response to light energy when exposed to light at an absorbable wavelength while it is not interacting with the metal (when separated from the metal for example), is especially preferred as the emitting/quenching part. The fluorescent dye is not particularly limited and can be selected appropriately according to the object from known dyes, but desirable examples include the compounds represented by the following structural formula and the like.

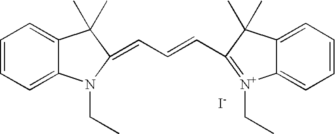

An example that can be used by preference as such a fluorescent marker is indocarbocyanine (C3) dye (trade name Cy3®).

### (Signal Intensity and Signal Amplitude)

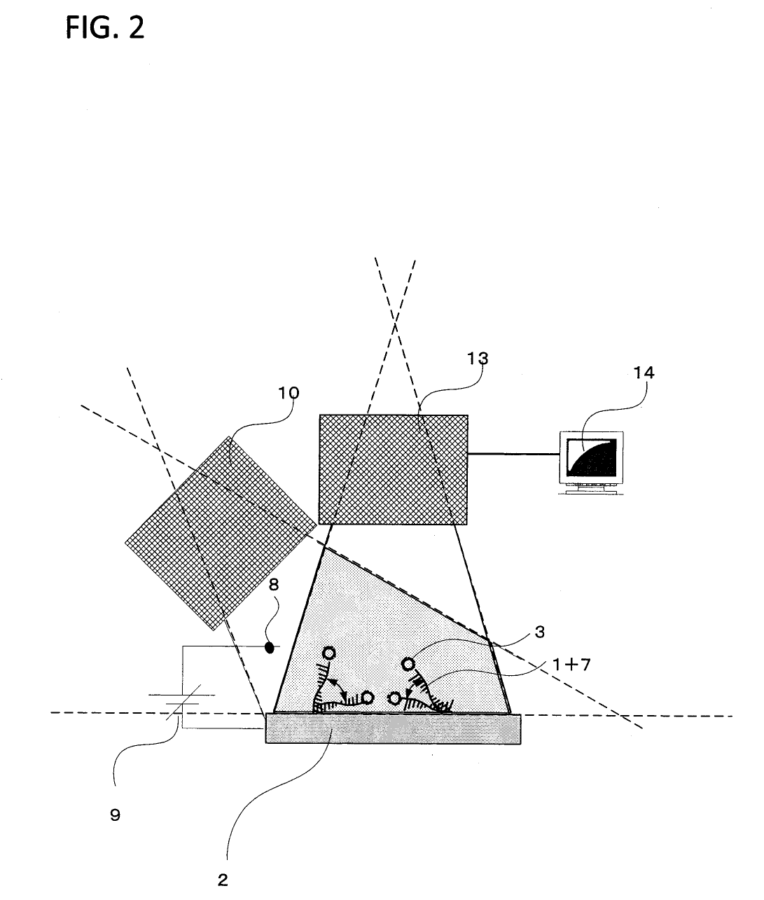

Using the target molecule evaluation apparatus of FIG. 2, the behavior of the resulting fluorescent signal was evaluated. FIG. 2 shows a combination of target molecule 7 and probe molecule 1 with a fluorescent marker bound to a substrate electrode on substrate 4, with fluorescence excited by light exposure part 10 being detected by fluorescence detection part 13. Signal display unit 14, which displays either the signal intensity obtained from Formula 1 or the signal amplitude obtained from Formula 2, is attached to fluorescence detection part 13.

In such cases, the signal intensity and signal amplitude are given by Formula 1 or 1′ and Formula 2 or 2′ below.

Signal intensity=fluorescence intensity with potential 1 applied−background fluorescence intensity (1)

Signal intensity=fluorescence intensity with potential 1 applied (1′)

Signal amplitude={(fluorescence intensity with potential 1 applied−fluorescence intensity with potential 2 applied)/(fluorescence intensity with potential 2 applied−background fluorescence intensity)}×100 (2)

Signal amplitude={(fluorescence intensity with potential 1 applied−fluorescence intensity with potential 2 applied)/(fluorescence intensity with potential 2 applied)}×100 (2′)

The fluorescence signal obtained with no probe molecule bound to the substrate electrode is here called the background fluorescence intensity. “Background fluorescence intensity” is so called because the fluorescence is believed to be an element unrelated to emission and quenching due to potential applied to the fluorescent marker on the probe molecule.

The potential at which the maximum fluorescence intensity is obtained when potential is applied and then varied with only the probe molecule bound to the electrode is taken as potential 1. This is thought to correspond to a state in which the probe molecule is elongated for example so that the emission from the fluorescent marker is least affected by the electrode. It is believed that by using this potential, the actual maximum fluorescence intensity can be obtained even when the probe molecule and target molecule are bound together.

In this way, the value either of the fluorescence intensity with potential 1 applied−the background fluorescence intensity, or of the fluorescence intensity with potential 1 applied, is believed to represent the fluorescence intensity during maximum emission due to binding of the probe molecule and target molecule.

In addition, the potential at which the minimum fluorescence intensity is obtained when potential is applied and then varied with only the probe molecule bound to the electrode is taken as potential 2. This is thought to correspond to a state in which the probe molecule is contracted for example, so that the emission from the fluorescence marker is most greatly affected by the electrode. It is believed that by using this potential, the actual minimum fluorescence intensity can be obtained even when the probe molecule and target molecule are bound together.

In this way, the “fluorescence intensity with potential 1 applied−the fluorescence intensity with potential 2 applied” represents the difference between fluorescence intensity during maximum emission and fluorescence intensity during minimum emission when the probe molecule is bound to the target molecule, and therefore it is thought that the fluorescence intensity attributable to binding between a probe molecule and a target molecule to the fluorescence intensity as a percentage of maximum fluorescence intensity, or in other words the amplitude, can be obtained by dividing this value either by “fluorescence intensity with potential 2 applied−background fluorescence intensity” or by “fluorescence intensity with potential 2 applied”, and multiplying by 100.

The difference between potential 1 and potential 2 corresponds to the amplitude of the AC potential. Because many probe molecules are negatively charged, potential 1 is often negative potential while potential 2 is often positive potential, but this is not necessarily the case. In implementing the present invention, potential 1 and potential 2 are determined first, and evaluation is performed using AC potential having this amplitude. In this case, it is often desirable to adopt a rectangular wave AC potential in order to prolong the time during which potential 1 and potential 2 are maintained.

In the aforementioned, “during minimum emission” can be seen as corresponding to “quenching” when fluorescence is represented as “emission and quenching”. In general, some fluorescence is still observed even when the fluorescence is quenched.

Research has shown that depending on the type of target molecule, there are cases in which only the signal amplitude is affected and there is no change in the signal intensity, cases in which only the signal intensity is affected and there is no change in the signal amplitude, and cases in which both the signal intensity and the signal amplitude are affected, but the target molecule can be evaluated by measuring at least one of the signal intensity and signal amplitude.

The reason that the signal amplitude changes may be that the fluorescence from the fluorescent marker is affected by some change in the movement of the probe molecule, such as elongation and contraction, or standing and lying of the probe electrode for example, due to binding between the probe molecule and the target molecule. This effect may be either an increase or decrease in fluorescence intensity, and for example it is thought that if a single-stranded DNA is converted to a double-stranded DNA as a result of binding between the probe molecule and target molecule, its structure becomes more rigid and the strand either stands vertical or lies horizontal with no intermediate state between the two, and the signal amplitude tends to increase. It is also thought that when the target molecule is a protein that binds specifically to the probe molecule, the effective Stokes radius increases, for example and there is more resistance from the water molecules of the medium, making movement of the probe molecule more difficult (that is, reducing the response to changes in applied potential), and thereby reducing the signal amplitude. If the target molecule binds non-specifically to the probe molecule, on the other hand, it is thought that the effective Stokes radius also increases for example, reducing the signal amplitude, but in this case the reduction in signal amplitude is much less than in the case of specific binding.

It is thought that perhaps the change in signal intensity occurs because the fluorescence from the fluorescent marker is absorbed by the target molecule and thereby quenched when the probe molecule binds specifically to the target molecule. For example, a quenching effect is known in which the aromatic amino acids contained in a protein absorb the fluorescence of a fluorescent marker. The quenching effect is sensitive to the distance between the probe molecule and target molecule (and is believed to be dependent on 1/r⁶, the distance between the target molecule and probe molecule), and appears strongly in the case of specific binding, i.e., close proximity or contact, while it is thought that no change in signal intensity occurs in the case of non-specific binding or in other words when the target molecule is not in close proximity or contact, simply surrounding the probe molecule.

Thus, it appears that a change in signal intensity is observed when the target molecule and probe molecule bind specifically, but when binding is weaker than in the case of specific binding, the signal amplitude is affected but the signal intensity is not greatly affected because there is little effect on the elongation and contraction, or standing and lying movement of the probe molecule. Actual data supporting this idea have been obtained as discussed below.

However, this is still only a hypothesis, and its validity has no effect on the intent of the present invention. That is, behaviors other than those described above are included in the scope of the present invention.

### EXAMPLES

Examples and comparative examples according to the embodiment in this specification are described in detail below, but the present invention is not limited thereby.

### Example 1

Using the target molecule evaluation apparatus of FIG. 2, the behavior of the resulting fluorescence signal was observed. The conditions were as follows.

Structure of electrode: Three layer structure of Au (200 nm thick), Pt (80 nm), Ti (10 nm), with Au on surface, diameter 2 mm

Structure of probe molecule: a double strand of

5′-[Thiol C6]-TAG TCG TAA GCT GAT ATG GCT GAT TAG
TCG GAA GCA TCG AAC GCT GAT TAA GTT CAT CTC GGT
TGG TGT GGT TGG-3′
and
5′-[Cy3]-ATC AGC GTT CGA TGC TTC CGA CTA ATC AGC
CAT ATC AGC TTA CGA CTA-3′.

An aqueous solution containing the contaminating protein albumin (BSA) (BSA liquid: BSA 2 wt %, 50 mM NaCl, 10 mM Tris-HCl, pH 7.4), aqueous solutions containing thrombin, the target molecule in this example (Tr liquid: 50 mM NaCl, 10 mM Tris-HCl, pH 7.4 buffer solution, adjusted to thrombin concentrations of 1 nM, 5 nM, 10 nM and 100 nM) and a wash buffer (50 mM NaCl, 10 mM Tris-HCl, pH 7.4) were prepared as samples. Each of these samples was supplied continuously to the target molecule evaluation apparatus until it was time to supply the next sample or wash liquid.

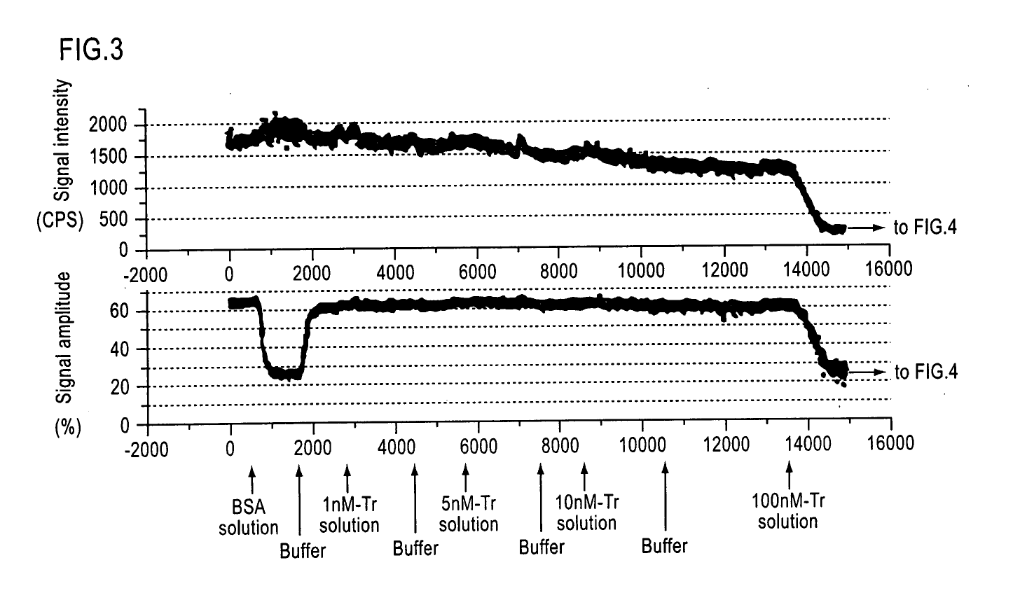

The resulting signal intensity and signal amplitude are shown in FIG. 3. Signal intensity is shown at the top and signal amplitude at the bottom of FIG. 3. The horizontal axis shows elapsed time (seconds) in both cases. A background fluorescence intensity of 560 cps was used.

According to FIG. 3, the signal amplitude changed greatly but the signal intensity did not change when BSA 2 wt % was supplied.

The signal amplitude returned to its original value when the wash buffer was supplied. This is thought to occur because the BSA2 binds weakly to the probe molecule and is easily washed away by the buffer.

Next, the 1 nM thrombin aqueous solution, the wash buffer, the 5 nM thrombin aqueous solution, the wash buffer and the 10 nM thrombin aqueous solution were supplied in the order shown in FIG. 3. As a result, the change in signal intensity was not obvious as long as the thrombin concentration was low, but appeared clearly with the 10 nM thrombin aqueous solution. No change in signal amplitude occurred during this time.

The fluorescence intensity declined gradually starting at 3000 seconds from the time when the 1 nM thrombin was first supplied until the end of washing at 8500 seconds. This is attributed not to the effect of thrombin on the probe molecule, but to the well-known photo-bleaching effect. A similar phenomenon appeared between 10500 seconds after the start of washing and 13500 seconds at the end of washing.

Both the signal intensity and signal amplitude changed when the 100 nM thrombin aqueous solution was supplied afterwards. The reason is not clear, but it is thought that as a result of binding between many probe molecules and many target molecules, the molecules became entangled, making it difficult for them to move in response to changes in potential.

In any case, this example showed that changes appear in either the signal intensity of signal amplitude as a result of binding between the probe molecule and target molecule. Consequently, it should be possible to use these changes to perform the various evaluations described above.

### Example 2

By determining the relationship between concentration and signal intensity and between concentration and signal amplitude for a particular target molecule in a sample and plotting them on a graph, it should be possible to detect a target molecule in an unknown sample from the signal intensity and signal amplitude, determine it comparatively with other molecules, quantitatively determine it, and evaluate the target molecule separately from contaminating substances.

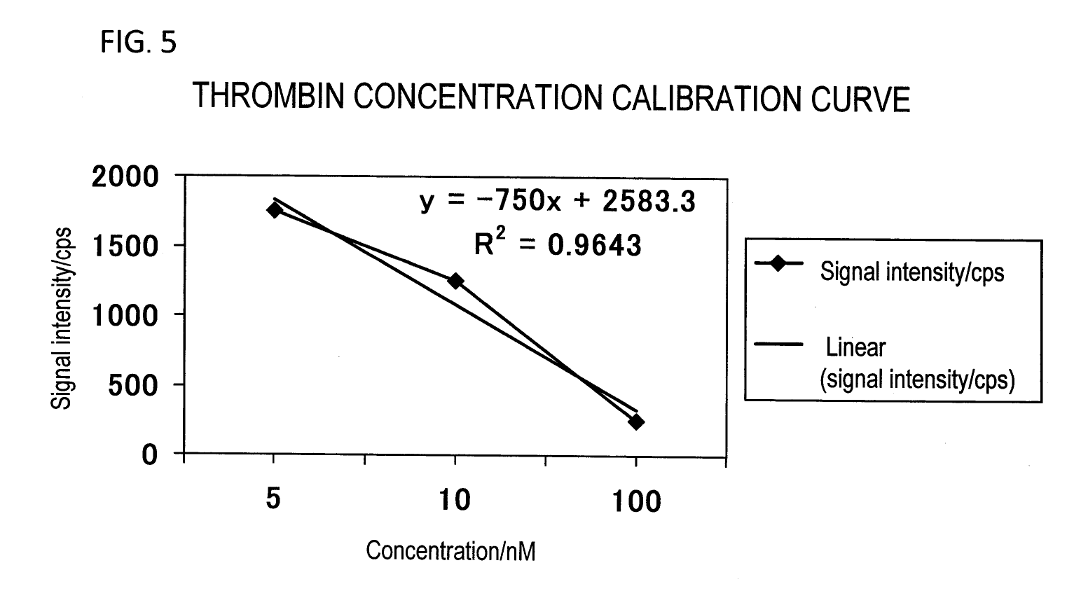

The signal intensity data for the 5 nM, 10 nM and 100 nM thrombin solutions of Example 1 (data 7500 seconds, 10500 seconds and 15000 seconds after start of supply of each solution) were plotted on the horizontal axis and the thrombin concentrations were plotted on the vertical axis to yield the graph of FIG. 5. Using this graph, it should be possible to easily determine an unknown thrombin concentration. In this case, even if contaminants are present they should not hinder concentration measurement if they are such as do not affect the signal intensity.

### Example 3

By investigating the relationship between concentration and signal intensity and signal amplitude in advance with respect to various molecules, it is possible to determine the target molecule comparatively with other molecules, determine the type of and quantitatively determine a molecule contained in an unknown sample, and evaluate the target molecule separately from contaminating substances and the like.

In this way, it is possible for example to quantitatively determine a target protein contained in a biological sample without first removing contaminants.

Since contaminating substances can be easily removed by washing, a target molecule can also be isolated by first performing such washing and then breaking the bonds between target molecule and probe molecule with “500 mM NaCl, 10 mM Tris-HCl, pH 7.4 buffer solution”, “50 mM NaCl, 10 mM Tris-HCl, pH 8.5 buffer solution” or the like.

If the relationship between concentration and signal intensity and signal amplitude is investigated with respect to a variety of molecules, it may be found that a group of target molecules or target molecules having a specific principal structure exhibit a similar pattern of relationships between concentration and signal intensity and signal amplitude. In such cases, even if the exact type of a molecule contained in an unknown sample cannot be determined, it may be possible to infer the group to which the molecule belongs or its specific principal structure.

### Example 4

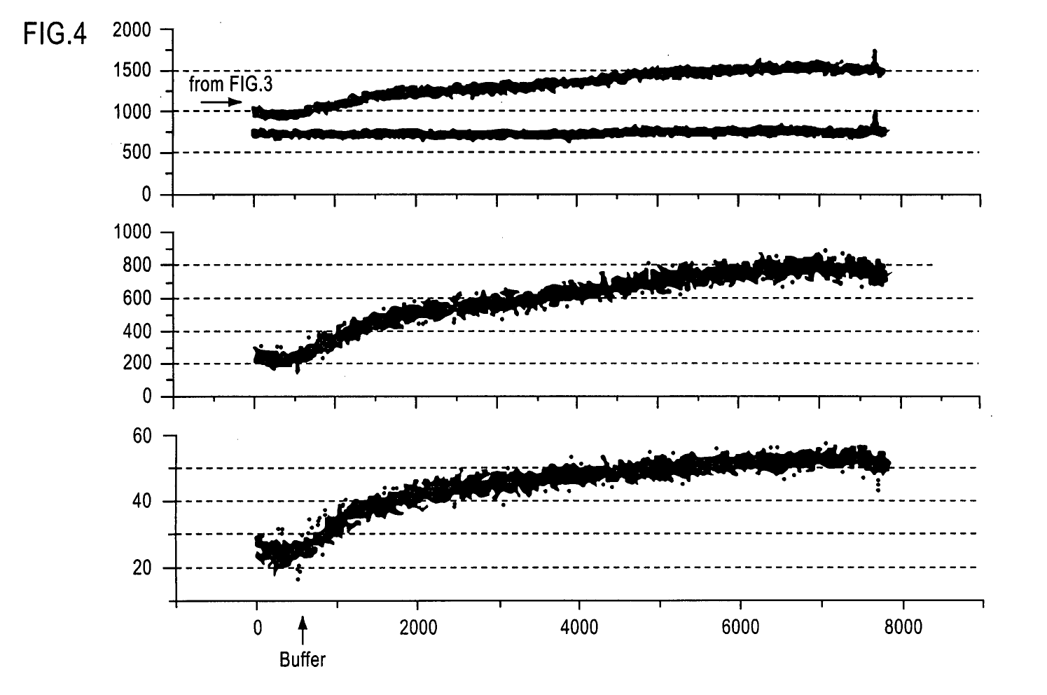

The dissociation constants were determined from the results of FIG. 4. The charts at the center and bottom of FIG. 4 are continuations of FIG. 3. The top of FIG. 4 also shows fluorescent intensity (top) during application of potential 1 and fluorescent intensity (bottom) during application of potential 2.

The dissociation constant K_{D} can be determined from the following formula by calculating the reaction rate constants from the measured fluorescent intensity or fluorescent amplitude.

K_{D}=k_{d}/kₐ

The reaction rate constants (dissociation rate constant and binding rate constant) can be calculated using either linear analysis or nonlinear analysis (simultaneous analysis or partition analysis). Nonlinear analysis (partition analysis) was used in this example. That is, the dissociation rate constant k_{d} is calculated by fitting either the fluorescent intensity of the dissociation region (FIG. 4) or the fluorescent amplitude from 500 seconds to 7500 seconds into the following formulae.

Signal intensity=R_{0 (signal intensity)·}e^{-kd·t}

Signal amplitude=R_{0 (signal amplitude)·}e^{-kd·t}

The binding rate constant Kₐ is calculated by fitting the dissociation rate constant k_{d} determined above and either the fluorescent intensity of the binding region (FIG. 3) or the fluorescence amplitude from 13000 seconds to 145000 seconds into the following formulae.

$$Signal intensity = \frac{{k}_{a} \cdot C \cdot {R}_{max ( signal strength )}}{{k}_{a} \cdot C + {k}_{d} \times \{ 1 - {e}^{- ( ka \cdot C + kd ) \cdot t} \}}$$

$$Signal amplitude = \frac{{k}_{a} \cdot C \cdot {R}_{max ( signal amplitude )}}{{k}_{a} \cdot C + {k}_{d} \times \{ 1 - {e}^{- ( ka \cdot C + kd ) \cdot t} \}}$$

(wherein C is the thrombin concentration and R is a constant). The dissociation constant as calculated from these formulae was K_{D}=5×10⁻⁹.

As is shown by Example 1, the evaluation of this example is possible even in the presence of albumin because the albumin does not affect the thrombin.

What is claimed is:

1. A target molecule evaluation method for evaluating a target molecule comprising:
applying AC potential between a substrate electrode provided on a substrate and a counter electrode;
bringing a sample into contact with a probe molecule bound to the substrate electrode, and
observing a fluorescent signal obtained from a fluorescent marker provided on the probe molecule to evaluate a target molecule in the sample that has bound to the probe molecule,
wherein the target molecule is evaluated by measuring at least one of a signal intensity obtained from Formula 1 or 1′ and a signal amplitude obtained from Formula 2 or 2′:
Signal intensity=fluorescence intensity with potential 1 applied−background fluorescence intensity (1)
Signal intensity=fluorescence intensity with potential 1 applied (1′)
Signal amplitude={(fluorescence intensity with potential 1 applied−fluorescence intensity with potential 2 applied)/(fluorescence intensity with potential 2 applied−background fluorescence intensity)}×100 (2)
Signal amplitude={(fluorescence intensity with potential 1 applied−fluorescence intensity with potential 2 applied)/(fluorescence intensity with potential 2 applied)}×100 (2′)
where the fluorescent signal obtained with no probe molecule bound to the substrate electrode is taken as a background fluorescence intensity,
potential 1 represents the potential at which maximum fluorescent intensity is obtained when potential is applied with only the probe molecule bound to the substrate electrode and when the potential is varied, and
potential 2 represents the potential at which minimum fluorescent intensity is obtained when potential is applied with only the probe molecule bound to the substrate electrode and when the potential is varied.

2. The target molecule evaluation method according to claim 1, wherein the target molecule bound to the probe molecule includes a target molecule bound specifically to the probe molecule.

3. The target molecule evaluation method according to claim 1, wherein the target molecule bound to the probe molecule includes a target molecule bound non-specifically to the probe molecule.

4. The target molecule evaluation method according to claim 1, wherein evaluation includes distinguishing between different target molecules bound specifically to the probe molecule or between a target molecule bound specifically to the probe molecule and a target molecule bound non-specifically to the probe molecule.

5. The target molecule evaluation method according to claim 4, wherein distinguishing between the target molecule bound specifically to the probe molecule and the target molecule bound non-specifically to the probe molecule is accomplished by comparing signal amplitude and comparing signal intensity.

6. The target molecule evaluation method according to claim 1, wherein the evaluation includes quantitatively determining a target molecule contained in the sample.

7. The target molecule evaluation method according to claim 1, wherein the evaluation includes determining a binding constant between the target molecule and probe molecule.

8. The target molecule evaluation method according to claim 1, wherein the probe molecule can be positively or negatively charged.

9. The target molecule evaluation method according to claim 1, wherein at least one of the probe molecule and target molecule includes at least one substance selected from the group consisting of proteins, DNA, RNA, antibodies, natural or artificial single-stranded nucleotide bodies, natural or artificial double-stranded nucleotide bodies, aptamers, products obtained by limited degradation of antibodies with proteases, organic compounds having affinity for proteins, biopolymers having affinity for proteins, complexes of these, positively or negatively charged ionic polymers and any combinations of these.

10. The target molecule evaluation method according to claim 9, wherein a single-stranded DNA is used as the probe molecule and a complementary-strand DNA for the single-stranded DNA is used as the target molecule.

11. The target molecule evaluation method according to claim 9, wherein a molecule having affinity for a protein is used as the probe molecule, and a protein bound specifically to a molecule having affinity for a protein is used as the target molecule.

12. A target molecule evaluation apparatus for evaluating a target molecule comprising:
applying AC potential between a substrate electrode provided on a substrate and a counter electrode;
bringing a sample into contact with a probe molecule bound to the substrate electrode; and
observing a fluorescent signal obtained from a fluorescent marker provided on the probe molecule to evaluate a target molecule in the sample that has bound to the probe molecule,
the target molecule evaluation apparatus comprising a signal detection and display part for detecting and displaying at least one of a signal intensity obtained from Formula 1 or 1′ and a signal amplitude obtained from Formula 2 or 2′:
Signal intensity=fluorescence intensity with potential 1 applied−background fluorescent intensity (1)
Signal intensity=fluorescence intensity with potential 1 applied (1′)
Signal amplitude={(fluorescence intensity with potential 1 applied−fluorescence intensity with potential 2 applied)/(fluorescence intensity with potential 2 applied−background fluorescence intensity)}×100 (2)
Signal amplitude={(fluorescence intensity with potential 1 applied−fluorescence intensity with potential 2 applied)/(fluorescence intensity with potential 2 applied)}×100 (2′)
where the fluorescent signal obtained with no probe molecule bound to the substrate electrode is taken as a background fluorescence intensity,
potential 1 represents the potential at which maximum fluorescent intensity is obtained when potential is applied with only the probe molecule bound to the electrode and when the potential is varied, and
potential 2 represents the potential at which minimum fluorescent intensity is obtained when potential is applied with only the probe molecule bound to the electrode and when the potential is varied.

13. The target molecule evaluation apparatus according to claim 12, wherein the target molecule bound to the probe molecule includes a target molecule bound specifically to the probe molecule.

14. The target molecule evaluation apparatus according to claim 12, wherein the target molecule bound to the probe molecule includes a target molecule bound non-specifically to the probe molecule.

15. The target molecule evaluation apparatus according to claim 12, wherein evaluation includes distinguishing between different target molecules bound specifically to the probe molecule or between a target molecule bound specifically to the probe molecule and a target molecule bound non-specifically to the probe molecule.

16. The target molecule evaluation apparatus according to claim 15, wherein distinguishing between the target molecule bound specifically to the probe molecule and the target molecule bound non-specifically to the probe molecule is accomplished by comparing signal amplitude and comparing signal intensity.

17. The target molecule evaluation apparatus according to claim 12, wherein the evaluation includes quantitatively determining a target molecule contained in the sample.

18. The target molecule evaluation apparatus according to claim 12, wherein the evaluation includes determining a binding constant between the target molecule and probe molecule.

19. The target molecule evaluation apparatus according to claim 12, wherein the probe molecule can be positively or negatively charged.

20. The target molecule evaluation apparatus according to claim 12, wherein at least one of the probe molecule and target molecule includes at least one substance selected from the group consisting of proteins, DNA, RNA, antibodies, natural or artificial single-stranded nucleotide bodies, natural or artificial double-stranded nucleotide bodies, aptamers, products obtained by limited degradation of antibodies with proteases, organic compounds having affinity for proteins, biopolymers having affinity for proteins, complexes of these, positively or negatively charged ionic polymers and any combinations of these.
